(19) United States
(12) Patent Application Publication
(10) Pub. No.: US 2005/0259178 A1
(43) Pub. Date: Nov. 24, 2005

(54) Image taking apparatus

(75) Inventor: Keiichiro Takahashi, Asaka (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/132,236

(22) Filed: May 19, 2005

(30) Foreign Application Priority Data
May 20, 2004 (JP) 2004-150898

(51) Int. Cl. H04N 5/235

(52) U.S. Cl. 348/363

(57) ABSTRACT

The present invention provides an image taking apparatus that performs favorable aperture correction. When a detection section detects that an image pickup device is interchangeably mounted, a microcomputer obtains information regarding the type of the image pickup device or the CCD via the detection section. Based on the obtained information, parameters according to the type of the CCD is set at an image processing section. Image data representing the object light captured by a lens is generated at the CCD and aperture correction is applied to the image data at the image processing section.

### BACKGROUND OF THE INVENTION

1. Field of the Invention

The present invention relates to an image taking apparatus that performs image taking by capturing object light with a current image pickup device out of plural image pickup devices available so as to cause the current image pickup device to generate an image signal.

2. Description of the Related Art

There has been conventionally proposed an image taking apparatus which incorporates plural image pickup devices of different resolutions and can perform image taking with different resolutions by selecting any of the image pickup devices. In addition, another type of an image taking apparatus has been proposed which is interchangeably equipped with any of plural camera heads provided with an image taking optical system and an image taking device, and which processes an image signal received from the camera head installed thereon (see, for example, Japanese Patent Application Publication No. 8-172561).

In both of image taking apparatuses described above, an image signal needs to be subjected to appropriate signal processing according to the type of an image pickup device as it is selected from several types of image pickup devices available. One of the signal processing is so-called aperture correction, which is the processing for emphasizing a frame of an object, and which requires information such as the pixel number and filter array of an image pickup device. In order to perform aperture correction desirably, various techniques have been proposed including; a technique that aperture correction is adjusted so as to obtain sufficient resolution in the case of a small aperture (see, for example, Japanese Patent Application Publication No. 6-14261), that aperture correction is performed according to the type of an exchangeable lens when mounted interchangeably to a camera head (see, for example, Japanese Patent Application Publication No. 2001-251549), and that desirable aperture correction is applied to the image signal taken by a network camera (see, for example, Japanese Patent Application Publication No. 2003-230023).

However, in the case where any one of plural image pickup devices is selected as shown in Japanese Patent Application Publication No. 8-172561, desirable aperture correction cannot be ensured if the content of aperture correction is changed according to technique shown in Japanese Patent Application Publication Nos. 2001-251549, 6-14261 and 2003-230023.

### SUMMARY OF THE INVENTION

The present invention has been made in view of the above circumstances, and provides an image taking apparatus which performs desirable aperture correction.

A first aspect of the present invention provides an image taking apparatus which takes an image by capturing object light with a current image pickup device out of plural types of image pickup devices available so as to cause the current image pickup device to generate an image signal, the image taking apparatus having:

an aperture correction section that applies aperture correction to the image signal,

wherein the aperture correction section performs aperture correction in accordance with the type of the image pickup device that generates the image signal.

According to the image taking apparatus of the invention, the aperture correction section can perform aperture correction based on the type of the image pickup device.

It is preferred that the plural types of image pickup devices are provided fixedly.

For example, in the case where plural image pickup devices are provided fixedly and any one of them is selected, if information corresponding to each of the plural image pickup devices is stored in a storage section in advance, and an apparatus is so configured that it reads information such as the pixel number and filter array of the image pickup device selected, desirable aperture correction can be performed based on the selection of the image pickup device, even with replaced image pickup device.

In addition, in the image taking apparatus of the invention, any of the plural types of image pickup devices may be interchangeably mounted rather than fixedly mounted. In such a case, detection section may need to be provided to detect the type of the image pickup device interchangeably mounted.

Further, it is preferred that any of plural types of image pickup units provided with an image taking optical system and an image pickup device is interchangeably mounted.

In the case such as Japanese Patent Application Publication No. 8-172561 where any of plural types of image pickup devices is loaded into a camera head that is interchangeably mounted on the camera body, if a storage section is provided in the camera head to store information of the image pickup device, and if the information in the storage section is made to be sent to the camera body when the camera head is interchangeably mounted on the camera body, desirable aperture correction can be performed based on the image pickup device provided in the camera head.

Further, a second aspect of an image taking apparatus that captures an object with an image pickup device and freely generates an image signal whose pixel array is thinner than the pixel array of the image pickup device, the image taking apparatus having:

an aperture correction section that applies aperture correction to the image signal,

wherein the aperture correction section performs aperture correction in accordance with the thinning condition of the image signal.

In this way, it is preferred that an image signal is generated for thinned pixel arrays rather than for all pixels, and aperture correction is preformed in accordance with thinning information at the image pickup device.

When a display screen provided in an image taking apparatus is used in place of a finder, moving image data or image data representing an object is generated at certain intervals at the image pickup device so that the object captured by an image taking lens is always displayed on the display screen in place of a finder. In this case, if aperture correction in accordance with thinning information of the image pickup device is performed as descried above, it can yield the effect of obtaining a clear image.

As described above, it is possible to realize an image taking apparatus in which favorable aperture correction can be preformed.

### BRIEF DESCRIPTION OF THE DRAWINGS

The invention will now be described with reference to the accompanying figures of which:

FIG. 1 shows an image taking apparatus according to an embodiment of the present invention;

FIG. 2 is a block diagram showing an internal configuration of the image taking apparatus of FIG. 1;

FIG. 3 is a flow chart showing processing procedures of a microcomputer 100;

FIG. 4 illustrates aperture correction, showing pixel arrays of two CCDs of different pixel numbers;

FIG. 5 shows an image taking apparatus according to another embodiment of the present invention;

FIG. 6 shows an internal configuration of an image taking apparatus in a case where an image pickup unit with an image pickup device and an image taking lens is further provided with a microcomputer; and

FIG. 7 shows a variation on FIG. 6.

### DETAILED DESCRIPTION OF THE INVENTION

An embodiment of the present invention will be described below with reference to the drawings.

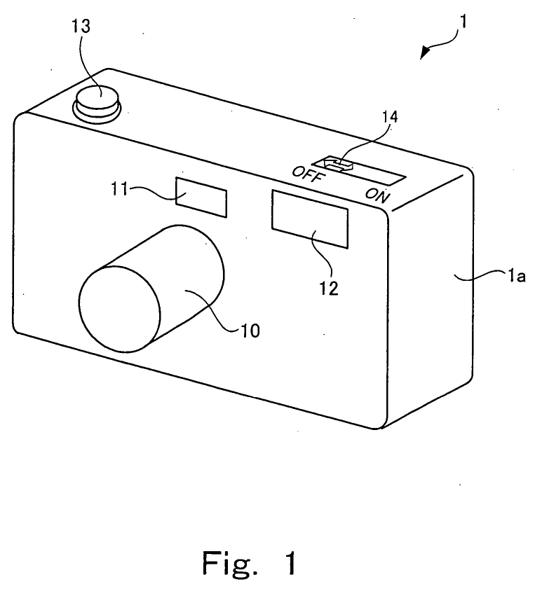

A camera body 1a of an image taking apparatus 1 shown in FIG. 1 has a lens barrel 10 in the center thereof, a finder 11 disposed above the lens barrel 10, and a flash-emitting window disposed next to the finder 11. When object brightness is insufficient, flash is emitted through the flash-emitting window to the object to take an image of the object. In addition, on the top of the camera body 1a, a release button 13 and a power switch 14 are provided. Further, on the bottom of the camera body 1a, although not shown, a loading port is provided for inserting an image pickup device (CCD solid-state sensor in the embodiment, hereafter referred to as CCD) into the camera body, so that an image pickup device can be interchangeably inserted therein.

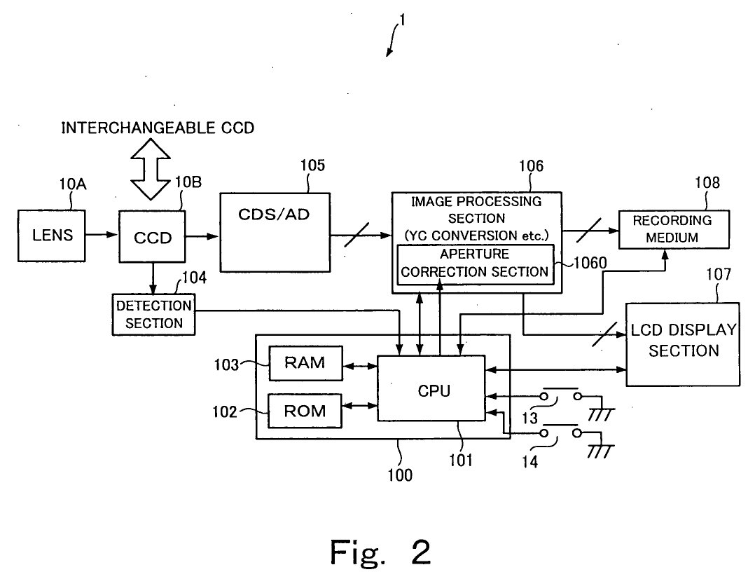

FIG. 2 is a block diagram showing an internal configuration of the image taking apparatus 1 of FIG. 1.

The whole operation of the image taking apparatus 1 is integrally controlled by a microcomputer 100. As shown in FIG. 2, the microcomputer 100 includes CPU 101, ROM 102 and RAM 103; ROM 102 is a main storage device used as a nonvolatile memory and stores a program describing operation procedure of the image taking apparatus; RAM 103 is an auxiliary storage device used as a volatile memory and stores processing variables which are used during processing performed by CPU 101 according to processing procedures in the program stored in ROM 102. When operation signals such as a power-on signal or a release signal is input to the microcomputer 100, CPU 101 starts processing to control operation of the image taking apparatus according to the procedures in the program stored in ROM 102. In addition to the program describing processing procedures, ROM 102 stores other information including the filter array and pixel number required for aperture correction, regarding the type of CCD 10B which is inserted through a loading port on the bottom of the image taking apparatus. In FIG. 2, when CCD 10B is inserted into the loading port and the insertion is detected by a detection section 104, the microcomputer 100 automatically obtains information regarding the type of CCD 10B.

Now, image taking processing using the image taking apparatus is briefly explained referring to FIG. 2.

First, when CCD 10B is inserted through the loading port and power switch 14 is turned on, the insertion of CCD 10B is detected by the detection section 104 and the information of CCD 10B is obtained by the microcomputer 100 through the detection section 104. Then, parameters according to such information is set in an image processing section 106. In response to the setting of parameters in the image processing section 106, the microcomputer 100 provides a timing signal at predetermined times to the CCD 10B so as to cause CCD 10b to output the image signal generated in CCD 10B to the image processing section 106. As the output signal is an analog signal, the output signal may include superimposed noise. Therefore, noise reduction is preformed at CDS part in CDS/AD section 105 before the image signal is supplied to the image processing section 106. Subsequently at AD part of CDS/AD section 105, the image signal is converted from analog signal to the digital signal which is supplied to the image processing section 106.

As mentioned before, because parameters necessary for aperture correction are set in the image processing section 106 by the microcomputer 100, image signals supplied to the image processing section 106 are always subjected to image processing including desirable aperture correction. In FIG. 2, aperture correction section 1060 included in the image processing section 106 indicates that aperture correction is performed within the image processing section 106. In addition to aperture correction, other image processing such as YC conversion and compression are performed in the image processing section 106. The image signal after subjected to aperture correction is supplied to LCD display section 107, so that the clear picture of the object is displayed as a through image on the display screen of LCD display section 107. As a user presses the release button 13 while watching the through image, the image signal to which aperture correction has been applied, is compressed based on the pixel number and filter array of the CCD 10B. The information regarding the compression together with the image data make up an image file, which is sent to a recording medium 108.

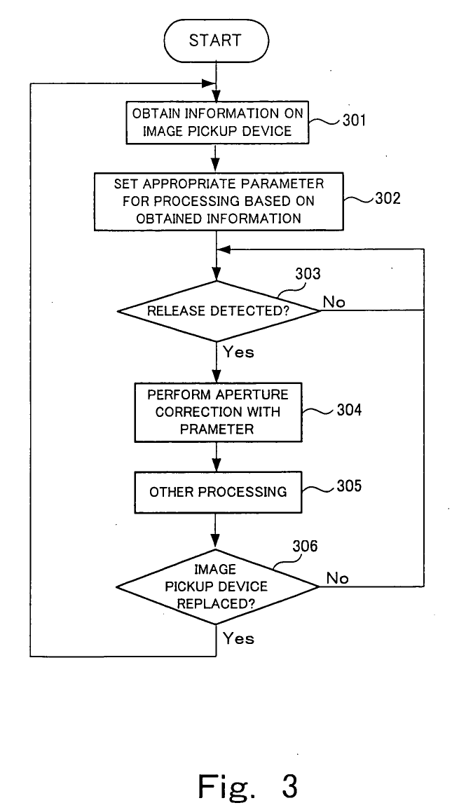

FIG. 3 is a flow chart showing processing procedures of the microcomputer 100.

After CCD 10B is inserted through the loading port on the bottom of the camera body, or when the power switch 14 is pressed while CCD 10B is being inserted, the following procedure starts.

At step 301, information regarding the type of CCD is obtained through detection section 104. At step 302, parameters necessary for appropriate processing to be performed by the image processing section 106 in accordance with the information obtained at step 301 is set in the image processing section 106. At next step 303, it is determined whether the release button 13 is pressed. If No, step 303 is repeated, and if Yes, it goes to step 304 where aperture correction based on the parameters that are set in the image processing section 106 is performed. At step 305, other processing except aperture correction are performed in the image processing section 106 and it goes to step 306 where it is determined whether CCD (image pickup device) is replaced. If No, it goes to No route to go back to step 303 and repeats the procedure from steps 303 to 306. If Yes, it goes to Yes route to return to steps 301 and repeats the procedure from step 301 through 306.

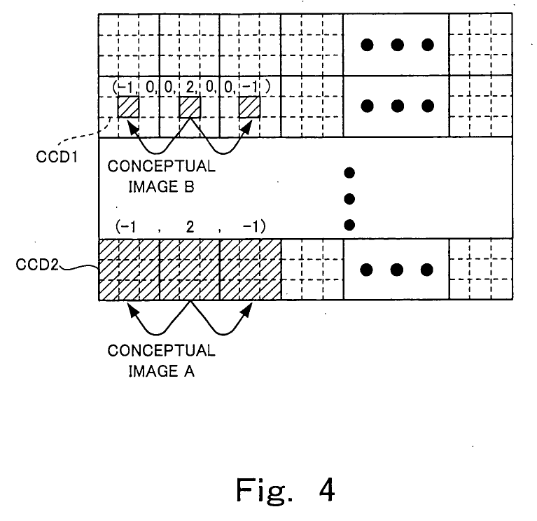

Now, referring to FIG. 4, aperture correction performed by the image processing section 106 is briefly described.

FIG. 4 illustrates aperture correction, showing pixel arrays of two CCDs of different pixel numbers described on the same level. For the sake of simplicity, in FIG. 4, the ratio of pixel number of CCD 2 versus CCD 1 is defined as 1 to 9. Relatively high pixel CCD 1 with many pixels and relatively low pixel CCD 2 with less pixels are shown on the same level being separated by dotted lines and solid lines. In order to discriminate two different pixel arrays shown on the same level, high pixel CCD 1 is denoted as conceptual image B, while CCD 2 is denoted as conceptual image A.

For example in the pixel array of low pixel CCD, the filter with three taps (the number is shown corresponding to a respective pixel) with (−1, 2, −1) shown horizontally is sufficient to perform edge emphasis in a horizontal direction. However, in the pixel array of high pixel CCD, the filter with seven taps (the number is shown corresponding to a respective pixel) with (−1,0,0,2,0,0,−1) is required in order to apply similar filtering to the pixel in the same position as that of low pixel CCD. In this way, if similar aperture correction is intended using the pixel in the same position, the number of taps in a filter may vary. However, according to the image taking apparatus of the present invention, parameters are set according to information of an image pickup device such as its pixel number and filter array, so that a filter of any configuration is available. According to the embodiment, information regarding the type of CCD is obtained in the microcomputer 100 as the information for image pickup device such as its pixel number and filter array, and corresponding parameters are set in the image processing section 106 according to the obtained information. Consequently, even when CCD 10B is replaced with another type of CCD, and therefore the pixel number and filter array of CCD 10B are changed, favorable aperture correction and other processing can be performed in the image processing section 106 according to the pixel number and filter array.

Now, brief explanation of filter operation will be made.

Taps, namely, filter coefficients of the filter for aperture correction denoted as (−1, 2, −1), indicate that each of three pixels arranged thereon is multiplied by the corresponding coefficient.

Given that the amplitude of each pixel is respectively X−1, X, and X₊₁, difference operation is performed twice as follows; (X−X₋₁)+(X₊₁−X). Repeating such difference operation between adjacent pixels yields same effect as differential operation, which has conventionally performed in analog circuits, so that the outline can be extracted. Although difference operation is performed twice in the embodiment, difference operation may be performed only once or more than twice. In addition, according to the embodiment, filter coefficients are represented in a row-vector form. If they are represented in column-vector form, difference operation is performed using three pixels arranged vertically. Further, if filter is denoted as “n×n” matrix, difference operation is performed using horizontally and continuously arranged n pixels, and vertically and continuously arranged n pixels.

Although FIG. 2 shows the case where a CCD is interchangeably mounted, plural types of CCDs may be fixedly provided in an image taking apparatus and any one of those CCDs may be selected. Further, any of plural types of image pickup units with an image taking optical system and an image pickup device may be interchangeably provided in an image taking apparatus.

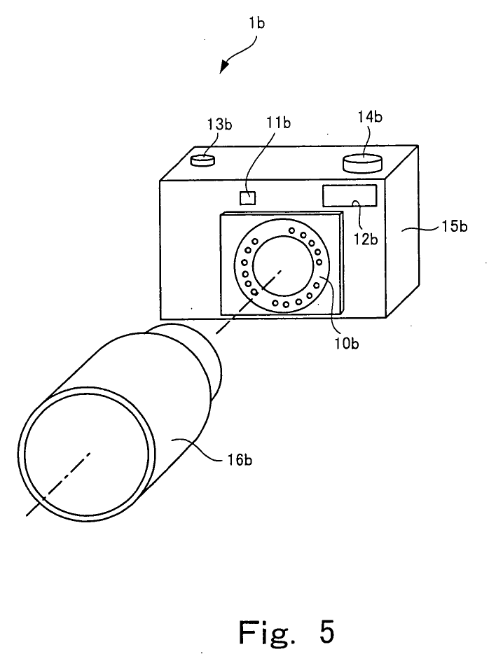

FIG. 5 shows the configuration of the image taking apparatus according to another embodiment of the present invention, in which the image pickup unit is interchangeably mounted on a camera body. More particularly, FIG. 5 shows an external view of the image taking apparatus in which the image pickup unit (camera head) 16b is interchangeably mounted on the camera body 15b.

Referring to FIG. 5, appearance of the image taking apparatus is briefly explained.

As shown in FIG. 5, the image taking apparatus 1b has the camera head 16b and the camera body 15b. The camera head 16b provided with an image taking optical system and an image pickup device is removably mounted on the camera body 15b which receives an image signal from the camera head 16b to perform signal processing.

The appearance of the camera head 16b is similar to that of the conventional interchangeable lens.

In the center of the camera body 15b, provided is head mount 10b with multiple mount contacts. The camera head 16b is also provided with a similar mount section. When the camera head 16b is mounted on the camera body 15b along a chain line shown in FIG. 5, each of multiple mount contacts in the camera head 16b is engaged with the corresponding mount contact in the camera body 15b, leading to electrical connection between the two.

Each of multiple mount contacts is allocated for communication or power supply, so that the camera body 15b reciprocally communicates with camera head 16b, and the camera body 15b supplies electric power to camera head 16b.

An AWB sensor 11b is provided above the head mount 10b, which detects the type of light source at the time of image taking. The type of light source, for example, sunlight or fluorescent lamp, is detected by the AWB sensor 11b, and the appropriate color temperature (for example 6000K for sunlight and 4500K for fluorescent lamp) is set at a digital signal processing section to obtain optimum white balance adjustment. Near the AWB sensor 11b a flash-emitting window 12b is provided, through which a flash-emitting device provided in the camera body 15b emits flash. Further, on top of the camera body provided are a release button 13b and a mode dial 14b. The mode dial 14b selects either of a replay mode or an image taking mode that further provides selection of a static image mode or a moving image mode. Further, a power switch is combined into the mode dial 14b, so that power is turned on by manipulating the mode dial 14b. Incidentally, FIG. 5 shows one example of plural camera heads and one example of plural camera bodies.

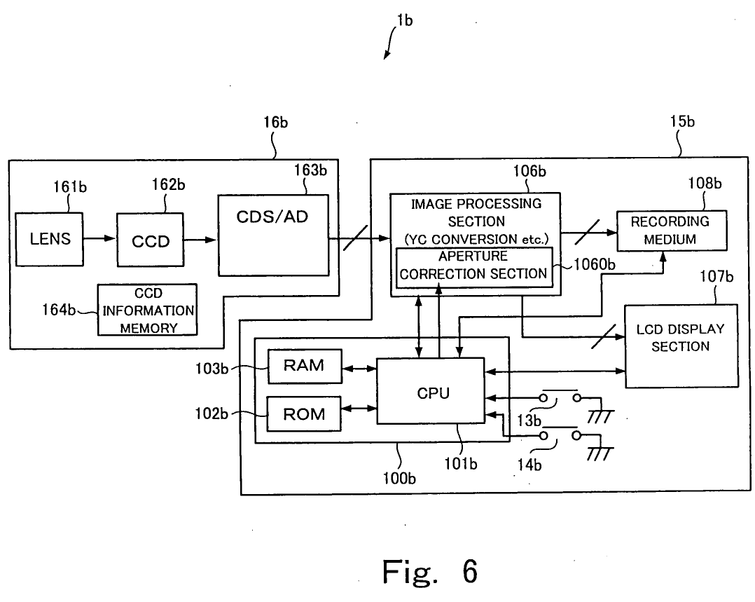

FIG. 6 shows an internal configuration of the image taking apparatus shown in FIG. 5, extracting only the system related to image signal processing.

As shown in FIG. 6, the image pickup unit 16b having an interchangeable lens 161b is separated from the camera body, drawing the line between a CDS/AD section 163b and an image processing section 106b. In addition, CCD information memory 164b is further provided in the image pickup unit 16b so that the microcomputer 100b can readily obtain information of the image pickup unit 16b, when the image pickup unit is mounted on the camera body 15b.

Therefore, when the image pickup unit is mounted on the camera body 15b, information in the CCD information memory 164b can be readily obtained by the microcomputer 100b in the camera body, thereby enabling swift setting of parameters at the image processing section. The configuration of FIG. 6 is same as that shown in FIG. 2 except that the image pickup unit 16b and the camera body 15b are separated and that CCD information memory 164b is further provided.

As described above, even with replacement of the image pickup device, it is possible to realize the image taking apparatus in which favorable aperture correction can be preformed.

Lastly explanation is made on another case where parameters of aperture correction is necessary. When supplying a timing signal to CCD at predetermined times to cause the subsequent component to output image signal, and when the image signal needs to be output in the state of thinned image signal, parameters of aperture correction must be changed.

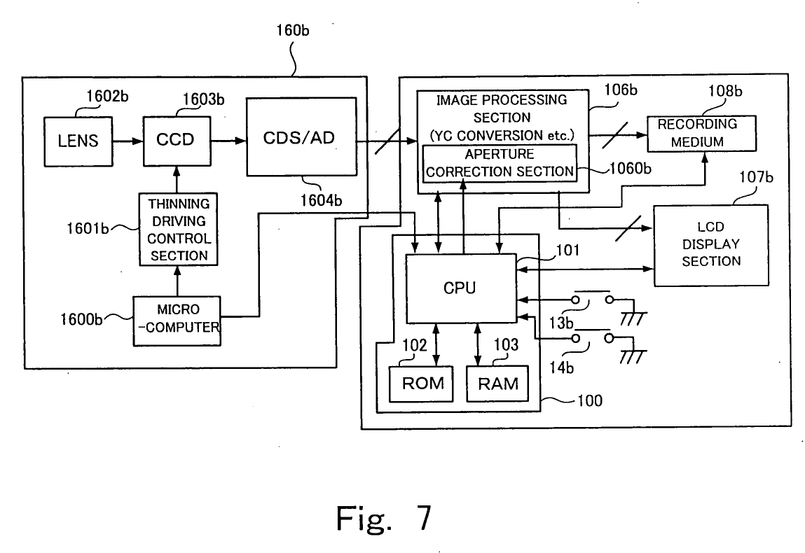

FIG. 7 shows a variation on FIG. 6, and provides a microcomputer 1600b provided in the image pickup unit 160b which is not included in the image pickup unit 16b of FIG. 6.

Recently, there is demand for high pixel for an image pickup device and high pixel CCDs have been developed which have relatively more pixels compared with conventional ones. However, with such a high pixel CCD, if the image signal composed of the image data of all the pixels is intended to be output at predetermined times from the CCD, tremendous processing procedures are necessary in subsequent operations. Therefore, with high pixel CCD 1603b with many pixels, usually image data is thinned so as to reduce the number of data to be output, and then image data representing a through image and moving image data are subjected to processing.

In FIG. 7, the microcomputer 100 in the camera body obtains information of thinning regarding driving of the CCD 1603b and according to the obtained information parameters are set at the image processing section 106b to apply aperture correction. Further, ordinary aperture correction is performed when the release button is pressed while an object is displayed on the screen.

As described above, aperture correction in accordance with thinned image data is applied before image taking, and clear image of the object is displayed on the screen of LCD display section 107b. When the release operation is conducted at a shutter chance, ordinary aperture correction is performed according to the release operation, so that high-precision image data is recorded in the recording medium 108b.

Similarly, when taking a moving image, aperture correction is applied according to the information of thinned image data, and subsequently the moving image data is recorded in the recording medium. Therefore clear moving image according to the moving image data is reproduced.

1. An image taking apparatus which takes an image by capturing object light with a current image pickup device out of a plurality of types of image pickup devices available so as to cause the current image pickup device to generate an image signal, the image taking apparatus comprising:
an aperture correction section that applies aperture correction to the image signal,
wherein the aperture correction section performs aperture correction in accordance with the type of the image pickup device that generates the image signal.

2. An image taking apparatus according to claim 1, wherein the plurality of types of image pickup devices are provided fixedly.

3. An image taking apparatus according to claim 1, wherein any of the plurality of types of image pickup devices is interchangeably mounted.

4. An image taking apparatus according to claim 1, further comprising a plurality of types of image pickup units provided with an image taking optical system and an image pickup device, in which any of the plurality of types of image pickup units is interchangeably mounted.

5. An image taking apparatus that captures an object light with an image pickup device and freely generates an image signal whose pixel array is thinner than the pixel array of the image pickup device, the image taking apparatus comprising:
an aperture correction section that applies aperture correction to the image signal,
wherein the aperture correction section performs aperture correction in accordance with the thinning condition of the image signal.
